(19) United States
(12) Patent Application Publication
(10) Pub. No.: US 2005/0076810 A1
(43) Pub. Date: Apr. 14, 2005

(54) Method and device for manufacturing a bitumen-bonded construction material mixture

(75) Inventors: Walter Barthel, Langenselbold (DE); Max Von Devivere, Ed Amersfoort (NL); Jean-Pierre Marchand, Montesson (FR)

Correspondence Address: DENNISON, SCHULTZ, DOUGHERTY & MACDONALD, 1727 KING STREET, SUITE 105, ALEXANDRIA, VA, 22314, US

(73) Assignees: Mitteldeutsche Harstein-Industrie AG; Eurovia GmbH & Eurovia

(21) Appl. No.: 10/638,467

(22) Filed: Aug. 12, 2003

Related U.S. Application Data
(63) Continuation-in-part of application No. 10/217,147, filed on Aug. 13, 2002, now abandoned.

(51) Int. Cl. C08L 95/00; C09D 4/00; C09D 101/00; C09D 201/00

(52) U.S. Cl. 106/282; 106/284.01; 366/7; 366/18

(57) ABSTRACT

The present invention relates to a process for producing a bitumen-bonded construction material mixture, the temperature of mixing of aggregates and bituminous binder being reduced. The invention also relates to a bitumen-bonded construction material mixture obtainable by the method according to the present invention as well as a device for manufacturing a bitumen-bonded construction material mixture.

The present invention relates to a method for producing a bitumen-bonded construction material mixture, the temperature of mixing of aggregates and bituminous binder being decreased. The invention also relates to a bitumen-bonded construction material obtainable by the method according to the present invention as well as a device for manufacturing a bitumen-bonded construction material mixture.

Bitumen is a mixture of high molecular weight hydrocarbons that is obtained by petroleum refinement. Bitumen is a dark colored, semi-solid to viscous mass of sticky consistency and having hydrophobic properties.

In virtue of its viscoelastic behavior, bitumen can be used at high temperatures. In most applications, for example for producing a bituminous coating in roadway construction or even for bituminous strips for roofs and insulation, the bitumen should be supplied by the refinery in the molten state and kept in insulated tanks.

In the context of the present invention, bituminous binder is defined as bitumen and/or any bitumen-based compositions. A bituminous binder according to the invention is a binder based on pure bitumen as well as binders containing any type of usual additive, in particular polymers.

Using mineral and/or synthetic aggregates it is possible to produce bitumen-bonded construction material mixtures that can be used with a hot bituminous binder, such as bituminous coatings or bituminous concretes.

Historically, bituminous coatings were produced in continuous processes, in drum mixers, and the bituminous concretes in discontinuous processes. The expression “bituminous concrete” is frequently associated with bituminous mixtures for rolled layers and the expression “bituminous coatings” with bituminous mixtures for other roadway layers.

In the context of the present invention, the expression “bituminous coating” means the bituminous coatings, still sometimes commonly called hydrocarbon coatings, and the bituminous concretes.

Classically, for manufacturing a bituminous coating, 4 to 7% by weight of bituminous binder is added to one ton of aggregate. For manufacturing hot-mix bituminous coatings, the mineral aggregates are initially dried in a drum then, if required, screened in order to be stored in the storage compartments, the aggregates are mixed in a mixer according to the formula to be produced, the temperature of the aggregate being in the range of 150° C. to 200° C. Then the bitumen is added by spraying to assure coating of the aggregates. The temperature of the bitumen varies normally between 140° C. and 190° C. as a function of the desired viscosity. In addition, fillers are added to the mixture and their introduction can be done before, during or after the spraying of the bitumen. The global holding time of the starting products in the mixer is 40 to 60 seconds, or 120 seconds. Further the discontinuous manufacturing—in other words, manufacturing in batches of bituminous coatings—a continuous manufacturing process is also known, wherein the operations are substantially the same, except for the fact that the coating operation is not done using a mixer.

The operation for drying the aggregates is costly in terms of energy and generates emissions of vapors and dust into the atmosphere.

The temperatures of the mixing step vary between 140 and 190° C. according to the type of bituminous binder; the coating temperatures can be higher in the case of special methods of coating such as hot-rolled methods in which the coating temperature is in the range of 200 to 250° C. High mixing temperatures represent a heavy energy expenditure and at the same time are an environmental pollution due to the undesirable gaseous effluents.

The elevated mixing temperature ranges induce decomposition in certain types of bitumens, which release blue fumes. Accordingly, the mixing temperatures that are lower have economical and ecological advantages.

Bitumen in the cold state is hard and becomes viscous or liquid when increasing the temperature. The bitumen changes continuously through all of the aggregation states, changing from the viscous state to the fluid state. This change of state is reversible and forms the basis of its utilization possibilities such as pumping, mixing and spraying. After the cooling step, the construction materials installed and bonded by the bitumen can be immediately loaded. The viscoelastic behavior of the bitumen forms the basis of the properties of employment of the construction material that is bound by the bitumen. Resistance to deformation is also favored and the same applies to its long-term strength. The elastic and plastic behavior of the bitumen should accordingly be transposed to the final product, for example a road covering. The ability to spread the bituminous coating and obtaining the necessary degree of compression of traffic surfaces depend upon the pliability of the bituminous coating so that higher mixing temperatures are selected in order to achieve an optimal end product.

Particularly hard types of bitumen require high mixing temperatures in order to allow, in the fluid state, coating and thus agglutination of the mineral and/or synthetic particles of the aggregate. Introduction of fine aggregates such as, for example fine dust into the bitumen results in a rigidization effect and thus to an increase in viscosity.

European patent EP 0 048 792 B1 discloses a method for producing a mastic bituminous coating which contains 0.2 to 5% by weight of a zeolite or a mixture of synthetic zeolite in the powder form to increase its stability. The zeolite powder particles have an average diameter of around 10 μm.

German application DE 43 23 256 A1 discloses the use of zeolite(s) in powder form for reducing the mixing temperature and the viscosity of the bitumen. The zeolite, preferably a type A zeolite, has a water content of 5 to 30% by weight. The zeolite powder particles have an average diameter of about 10 μm.

Use of powdered zeolite as described in the prior art documents involves technical problems during the handlinge; namely, problems of flow behavior and safety owing to the handling of powders, especially during the introduction of the powdered zeolite into the mixer (coater). This is, inter alia, a reason why the methods described in applications EP 0 048 792 and DE 4323256 have never been operated.

The applicant has unexpectedly discovered that the introduction of an additive having a high desorption apability with temperature, in the form of granules, prior to and/or during spraying of the bituminous binder makes it possible to solve the complex double technical problem of improving handling and fluidity of the additive before and during the addition into the mixer (coater), while enabling said additive, once it has been added, to rapidly develop in situ improved technical characteristics.

The addition of the additive in the form of granules makes it possible to reduce the coating temperature. This reduction of the coating temperature allows a reduction in energy consumption, the emission of vapors and dust into the atmosphere and the production of greenhouse effect gases, such as carbon dioxide.

In the context of the present invention, the term “aggregate(s)” means the mineral and/or synthetic aggregates which are introduced into bituminous binders in order to manufacture mixtures of materials used in construction.

In the context of the present invention, the term “granule(s)” means the granules of additive having high desorption ability with temperature that are introduced into the mixer (coater) prior to and/or during the spraying of the bituminous binder.

The present invention thus relates to a method for producing a bitumen-bonded construction material mixture, in particular a bituminous concrete or bituminous coatings, comprising the following steps:
a) drying, in a mixer (coater) device, of aggregate at a temperature T₁ of between 110 and 160° C., then
b) coating of said aggregates that are at temperature T₁ by spraying into the mixer (coater) device of a bituminous binder which is heated to a temperature T₂ of between 140 and 190° C.;
and wherein prior to and/or during the spraying of the bituminous binder, an additive having a high desorption ability with temperature is introduced into the mixer (coater) in the form of granules, said granules comprising fine particles of said additive aggregated using a adhesive, said fine particles having an average diameter of between 2 μm and 4 μm.

In the context of the present invention, the term “average diameter” is defined as the arithmetic mean of the individual diameters of the particles measured by laser granulometry.

In one preferred embodiment of the invention, the temperature T₂ of heating of the bituminous binder is higher, advantageously by approximately 30° C., than temperature T₁ of drying of the aggregates.

Advantageously, the bituminous binder is heated at its typical coating temperature and the aggregates are dried at a temperature which is about 30° C. lower than said typical coating temperature. In particular, the drying temperature of the aggregates is 130° C. and the temperature of heating of the bituminous binder is 160° C.

During the coating the aggregates by the bituminous binder, the temperature of the bituminous binder tends to approach the one of the aggregates due to the fact that aggregates constitute the largest part of the mixture. In fact, a bitumen-bonded construction material comprises, for example, about 94% of aggregates and 6% of bitumen. If it is assumed that the aggregates are heated to a temperature of 130° C., that the bituminous binder is heated to a temperature of 160° C., that the specific heat capacity of the aggregates is 0.2 th/t and the one of the bituminous binder is 0.5 th/t, that the proportions of aggregate relative to bitumen are respectively 94% and 6%, the mixing temperature is thus 134° C. Accordingly, if the drying temperature of the aggregates is reduced, the temperature of coating is less important, the temperature of bituminous binder decreases and its viscosity increases. Coating thus becomes more difficult. The purpose of introduction of the additive is to compensate for this drawback. Under the effect of the temperature of the aggregates, the additive in the form of granules releases the water that it contains in solid form and thus artificially reduces the viscosity of the bituminous binder and thus improves the quality of coating.

In the context of the present invention, the expression “additive having a high desorption ability with temperature” means any additive able of releasing, under the action of heat, in other words at a temperature above 110° C., molecules of water that are situated between the layers or the interstices of its crystalline matrix. Typically, this physically imprisoned water is known as “zeolitic water.”

Advantageously, an additive is used whose water content varies from 5 to 30% by weight, in particular from 15 to 25% by weight relative to the total weight of the additive.

The granules comprise fine particles of said additive aggregated by means of a adhesive. These fine particles of said additive can especially be obtained by wet granulation. Then, they are aggregated using a binder or an adhesive in order to create granules of an average diameter of between 0.2 mm and 1 mm.

Said adhesive can be, in particular, a derivative of cellulose. An adhesive particularly suited for aggregating the fine particles of said additive is carboxymethyl cellulose (CMC).

For many reasons, it is preferable to handle the additive in granule form rather than handling the same additive in powder form. In fact, the granules, compared with powders, have in particular the following advantages:
better handling (stocking, transport, dosing);
dust formation remains limited;
better fluidity;
no curing.

The applicant has similarly unexpectedly discovered that the introduction of the additive in the form of granules allows a more rapid distribution of the additive in the mixer (coater) prior to and/or during the spraying of the bituminous binder. The coating step lasts only approximately 40 seconds, up to a maximum of 120 seconds; so it is important that the additive can release a maximal quantity of its zeolitic water during this short period. Once the additive granules are introduced into the mixer (coater), the fine particles of said additive are no longer bonded to each other. Thus in the mixer (coater) there are fine particles of additive which have an average diameter of between 2 and 4 μm. It would be difficult to introduce the said fine particles non bonded into the mixer (coater) due to the numerous technical problems connected with handling powders.

In one advantageous embodiment of the invention, the fine particles of said additive have a specific surface of between 8,000 and 26,000 cm²/g, advantageously at least 15,000 cm²/g, measured by laser granulometry.

At the time of laboratory assay, the applicant found that the additive in the form of granules after elimination of the adhesive, releases more than 70% of its water in less than 6 hours at a temperature of between 140 and 180° C. The same additive in the form of a powder, having an average diameter of 10 μm, releases more than 70% of its water in approximately 15 hours at a temperature of between 140 and 180° C. in laboratory assays.

According to one advantageous alternative embodiment of the invention, the additive used is a natural and/or synthetic zeolite or its initial amorphic synthesis stage.

Advantageously, fiber zeolite, leaf zeolite and/or cube zeolite is used as the zeolite. Faujasite, chabasite, phillipsite, clinoptilolite and/or paulingite is used as the zeolite.

Advantageously, the zeolite used is a synthetic zeolite of the A, P, X and/or Y type. Preferably, a type A zeolite granule, in particular having the chemical formula Na₁₂(AlO₂)₁₂(SiO₂)₁₂, 27H₂O, wherein the quantity of Na₂O is 18%, Al₂O₃ is 28%, SiO₂ is 33% and H₂O is 21%.

By comparison to the zeolites of natural origin, the artificial zeolites frequently have a constant uniformity and quality, which is advantageous in particular for the required fineness.

According to one advantageous alternative embodiment of the invention, the additive is introduced into the mixer (coater) at a quantity of 0.1 to 5% by weight, in particular 0.2 to 0.8% by weight relative to the total weight of the mixture.

Pursuant to the invention, a method for producing bitumen-bonded construction material mixture is made available, which compared to familiar production methods is conducted at considerably lower mixing temperatures without increasing undesirably the viscosity. It confers an elevated flexibility, which makes possible improved implementation, to the bituminous coatings or to bituminous concrete so manufactured.

Without limitation to any particular theory, it can be that the additive, having a high desorption ability with temperature, progressively releases the zeolitic water at the time of coating and also during transport or the phase of implementation of the mixture comprising a bituminous binder. This progressive release of the water allow for the mixture to remain more pliable over a longer period of time due to the successfully release water without making temperature increases and thus increases viscosity changed necessary. Due to the fact that the pliability of the mixture is influenced positively, the construction material mixture exhibits a compression willingness that would generally be accomplished at higher temperatures. The released water brings about a foaming of the bituminous binder without negatively influencing it so that the aggregates are coated to the desired extent. Said foaming effect is expressed by an increase in volume that positively influences the bituminous mixture. The fine-particle water vapor bubbles form micropores, which result in a low gross density of the construction material mixture. A particular advantage consists in that the volume increase, which is itself rather low, confers to the bituminous coating a clearly improved compressibility for compacting operations. The additive ensure a uniform distribution of the water vapor in the hot mixture comprising a bituminous binder. An event distribution of the water vapor in the bitumen-bonded hot mixture is ensured particularly through zeolite as the water donor. In this case, it is decisive that the water release does not occur spontaneously at the oiling point but instead occurs continuously in the temperature range of from 110 to 160° C. According to an advantageous alternative embodiment of the invention, fillers are in addition introduced prior to and/or during the spraying of the bituminous binder. These fillers ensure uniform distribution of the additive having a high desorption ability with temperature in the hot mix. Advantageously, the fillers are introduced at the same time as the additive. According to an advantageous alternative embodiment, the fillers are rock dusts.

The bituminous binders envisaged are most particularly bitumen, special bitumens, modified bitumens, polymer modified bitumens or mixtures thereof.

With the method of the invention, a drop in the mixing temperature by 30° C. to 40° C. can be accomplished, reducing the need for energy by about 30. Measurements have shown that the specific energy requirement can be lowered by 14 kWh per ton of bituminous coating. When considering a coating system that during normal operation requires 8 liters of fuel oil per ton of bituminous coating, this means a saving of 2.4 liters. Assuming that, the annual production of coatings in Germany (respectively in France) is about 65 million tons (respectively 40 million tons), this means savings of 400,000 tons of carbon dioxide (respectively 246,000 tons).

In addition, it should be pointed out that a lower temperature bituminous material mixture creates fewer aerosols and vapors. Measurements were also able to prove the reduction of emissions of pollutants. A lower percentage of noxious and odorous substances was also detectable. Measurements in the context of coating trials have given a value of 350.7 mg of aerosol vapors per cube meter of air for the utilization of a standard B65 bitumen at a coating temperature of 168° C. and a value of 90.4 mg per cube meter of air for a coating temperature of 142° C., due to the additive in the form of granules having a high desorption ability with temperature, in particular a zeolite. A lowering of the mixing temperature by 26° C. thus resulted in a reduction of ultrafine particles by 74%.

Considerable changes are also experienced with the odor. Olfactory evaluations with subjects resulted in a lower number of odor units (OU) in the case of a construction material mixture that was produced at lower temperature on the basis of the teaching of the invention by comparison to a coating manufactured at a normal temperature of coating. With regard to the spreading behavior, no disadvantage could be detected compared to regular bituminous coatings. The desired surface structures were also achieved without difficulty.

Changes with regard to usage properties, stability, gripping capacity, weather resistance and durability were not been noticed. The bituminous construction material mixture that was produced to the invented method consequently exhibits the same properties as the material produced at higher temperatures.

A further object of the present invention is a bitumen-bonded construction material mixture, in particular a bituminous concrete or bituminous coatings, obtainable according to the present invention, wherein, at the time of its implementation the emissions of aerosols are less than 0.5 mg/m³, advantageously less than 0.36 mg/m³.

At the time of implementation of the bituminous coatings on a road construction site, the aerosol emissions were measured in the vicinity of the paver driver, the compactor driver, and the table of the paver.

A paver is a self-propelled roller vehicle that, receiving the ready-to-use material, spreads it, levels it, tamps and smooths it providing after its passage a finished coating. A compactor is a machine that reduces, by vibration, rolling or ramming the apparent volume of the bituminous coatings.

Advantageously, at the time of application of the building material according to the present invention, the aerosol emissions and vapor emissions in the vicinity of the:
paver driver are between 0.5 and 1 mg/m³;
compactor driver are less than 2 mg/m³, and
the paver table are between 0.36 and 0.6 mg/m³.

A further object of the present invention is the utilization of an additive having a high desorption ability with temperature, in the form of a granule, for controlling the temperature of the mixture comprising the granule and the bituminous binder, insofar as the mixture remains intact. The granules of the additive comprise fine particles of said additive having a average diameter of between 0.2 and 0.4 μm. The fine particles are bonded to each other by means of a binder or an adhesive. The adhesive can, in particular, be a derivative of cellulose such as carboxymethyl cellulose. Advantageously, the granules of the additive have an average diameter of between 0.1 and 2 mm.

According to one advantageous alternative embodiment, the additive used is a natural and/or synthetic zeolite, or its initial amorphous synthesis phase. Advantageously, the zeolite is a fiber zeolite, a leaf zeolite and/or a cube zeolite. The zeolite used to can belong to the group comprised of fajasites, chabasites, philipistes, cliloptilosites and/or pauligistes. Still more advantageously, the zeolite used is a synthetic zeolite of the A, P, X and/or Y type. Preferably, a granule of type A zeolite is used, in particular having the empirical formula Na₁₂(AlO₂)₁₂(SiO₂)₁₂, 27H₂O, wherein the quantity of Na₂O is 18%, Al₂O₃ is 28%, SiO₂ is 33% and H₂O is 21%.

It is recommended to use an additive, whose water content is between 5 and 30% by weight, in particular between 15 and 25% by weight relative to the total weight of the additive.

According to an advantageous alternative embodiment of the invention, the additive is introduced into the mixer (coater) at a quantity of 0.1 to 5% by weight, in particular 0.2 to 0.8% by weight with respect to the total weight of the mixture.

Advantageously, said additive allows to maintain the temperature of the mixture at approximately the temperature of coating attained at the end of step b), while the mixture remains intact. The temperature of coating attained at the end of step h) can be calculated using the following formula:
Tₑ=(c_{g}×m_{g}×Tᵢ+c_{L}×m_{L}×T₂)(m_{g}×c_{g}+m_{L}×c_{L})
wherein Tₑ represents the specific heat of the aggregate
c_{g} represents the specific heat of the granule
m_{g} represents the quantity of the granule
T₁ represents the temperature of drying of the granules defined in step a)
c_{L} represents the specific heat of the bituminous binder
m_{L} represents the quantity of bituminous binder
T₂ represents the heating temperature of the bituminous binder, defined at step a).

At the time of its passage into the screw of the paver, the coating is distributed and the thermal exchanges with the exterior are more significant. Prior to this step, it can be considered that the coating “remains intact” both in the truck and in the hopper of the paver.

A further object of the present invention is the use of said additive for increasing the handling of a a bitumen-bonded construction material mixture, in particular a bituminous concrete or bituminous coatings.

In particular, said additive having a high desorption ability with temperature allows to increase handling of a mixture for use in construction comprising a bituminous binder, in particular a bituminous concrete or bituminous coatings under atmospheric conditions of implementation which are difficult, in particular at ambient temperatures from 5 to 10° C. Working at cooler ambient temperatures can also be proposed. However, it appears difficult to work at ambient temperatures lower than 2° C.

The coating temperatures being the same, the addition of additive such as hereinbefore described, makes it possible to improve handling of the bituminous mixture. This property is particularly advantageous when working outdoors, at ambient temperatures at the limit of the usual tolerances. If one wishes to apply the coating or the bituminous concrete not containing this additive at a thickness greater than 5 cm, for example a wearing layer or road layer, the ambient temperature must be greater than 5° C. For a thickness of less than 4 cm, the ambient temperature must be greater than 10° C.

Under extreme atmospheric conditions of implementation, regular bituminous coatings cannot be spread because of the excessively great temperature difference between the ambient air and the temperature of the bituminous coatings. In fact, on contact with the ambient air, the coating cools, the temperature of the binder drops resulting in an increase in its modulus and likewise a rigidification of the coating. In consequence, handling of the bituminous coating decreases resulting in compacting difficulty. The addition of said additive allows to improve handling of the bituminous coatings regardless of significant temperature differences and thus makes it possible to continue to work with the bituminous coatings under extreme atmospheric conditions. It should be noted that when the ambient air is at a temperature of between 5 and 10° C., even between 2 and 10° C., the ground can be at an even lower temperature.

The present invention also relates to a device for producing a bitumen-bonded construction material mixture, in particular a bituminous concrete or bituminous coatings comprising a mixer (coater) mixing the mineral and/or synthetic aggregates, the bituminous binder, the additive having a high desorption ability with temperature and, if required, fillers.

A device for producing a bitumen-bonded construction material mixture, in particular a bituminous concrete or bituminous coatings, comprising a mixer (coater) mixing a mineral and/or synthetic aggregate, a binder and, if required, fillers, is distinguish by the fact that the device is assigned a silo, in which an additive having a high desorption ability with temperature is stored, that a weighing device for the metered feeding of the additive into the mixer (coater) is located after the silo and that the weighing device is connected with the mixer (coater) by means of a conveyor device. In this case, the conveyor device can be a conveyer such as a screw conveyor for the fillers that are to be fed to the mixer (coater). The conveyor device can also be a pneumatic conveyor, which leads to the spraying device present in the mixer coater, such as a nozzle.

In the case of a mobile silo, it should have standard dimensions so that it can be transported on a truck, in particular on a heavy-duty truck.

For the purpose of removing the additive from the silo, a cell wheel lock is provided, from which the additive is supplied to the weighing device. So as to make a mobile device available that is easy to handle, it is furthermore suggested to arrange control, weighing and conveying devices for a truck that can be aligned with the silo.

In summary, it can be said that with regard to the mineral substances composition, type and quantity of the bituminous binder, time sequence of the mixing process and mixing performances a bitumen-bonded construction material mixture produced with the method of the present invention, in particular a bituminous concrete or bituminous coatings, corresponds to a bituminous construction material mixture that has been produced pursuant to the state of the art at higher temperatures.

Introducing the additives and their separate weighing process itself requires no change in the batch mixing times so that the production output remains the same as that of conventional systems. The same applies for the case that instead of a batch operation a continuous operation is performed.

By lowering the bituminous mixture temperature by more than 30° C., lower specific energy requirements are necessary. The resulting energy savings lead to lower CO₂ emissions into the atmosphere and to reduce pollutant and odor percentages, owing to which a protection of the environment takes place. Due to the fact that the process takes place at lower temperatures, a reduction in the wear of the part of the apparatus can be achieved. The lowering of the temperature of the bituminous binder due to the reduced drying temperature lead to reduce oxidation values and thus a curbed aging of the bituminous binder with the consequence that a longer life of the bituminous fortifications is attainable.

The following figures represent a particularly suitable device according to the present invention.

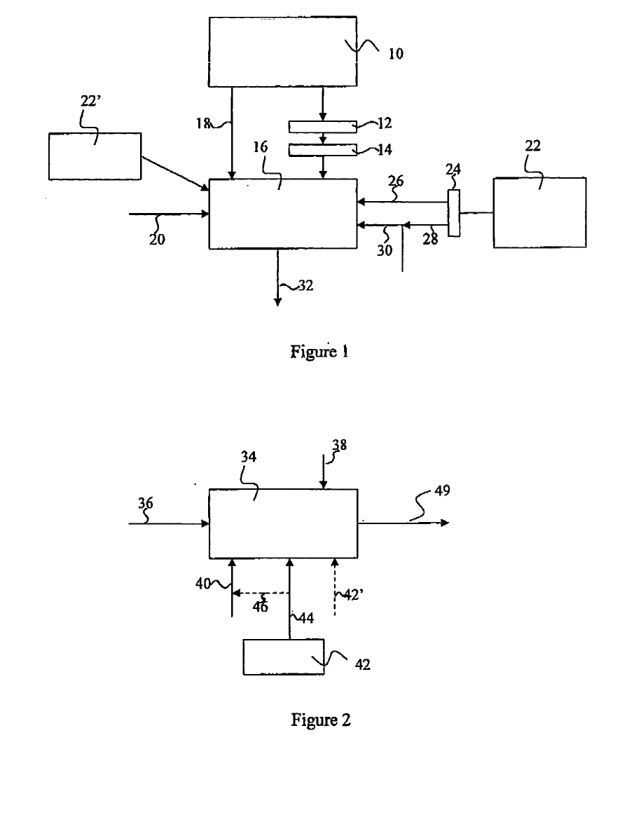

FIG. 1 represents a diagram of the producing process of a bitumen-bonded construction material mixture;

FIG. 2 represents a second diagram of the producing process of a bitumen-bonded construction material mixture;

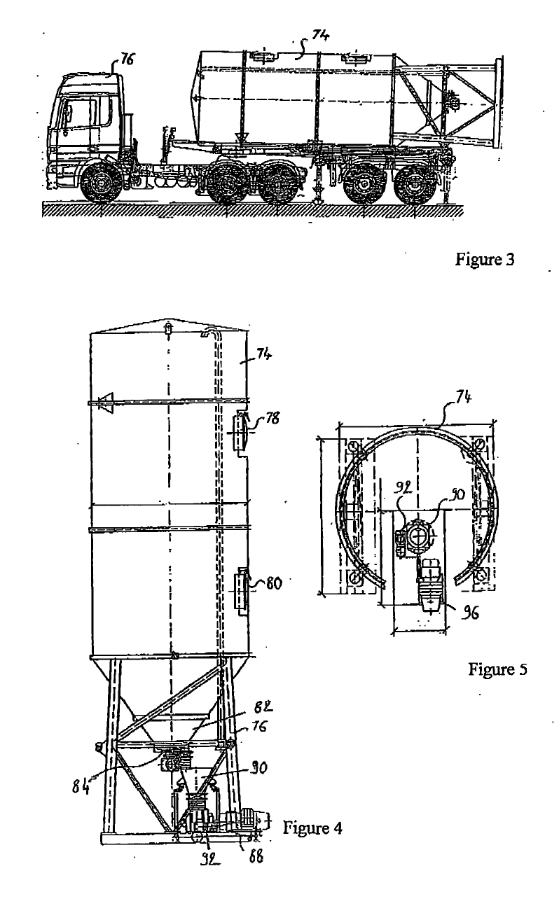

FIG. 3 represents a silo transported on a truck;

FIG. 4 represents the silo according to FIG. 3 in the operating state;

FIG. 5 represents a top view onto the silo pursuant to FIG. 4;

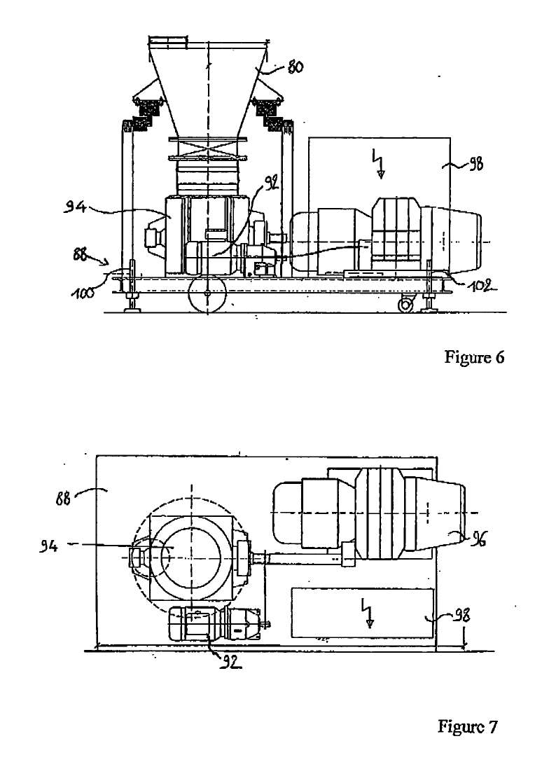

FIG. 6 represents a block diagram showing a cart with weighing and conveying devices;

FIG. 7 represents a top view of the cart pursuant FIG. 6;

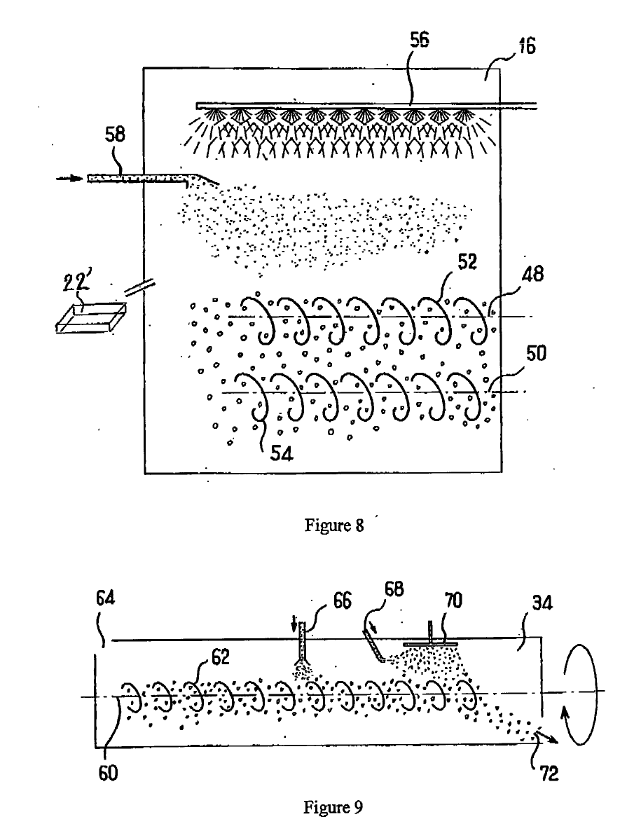

FIG. 8 represents a block diagram showing a mixer for producing a bitumen-bonded construction material mixture, and

FIG. 9 represents an embodiment of a mixer (coater).

The following figure represents the properties of the bituminous coatings obtained by the method according to the invention.

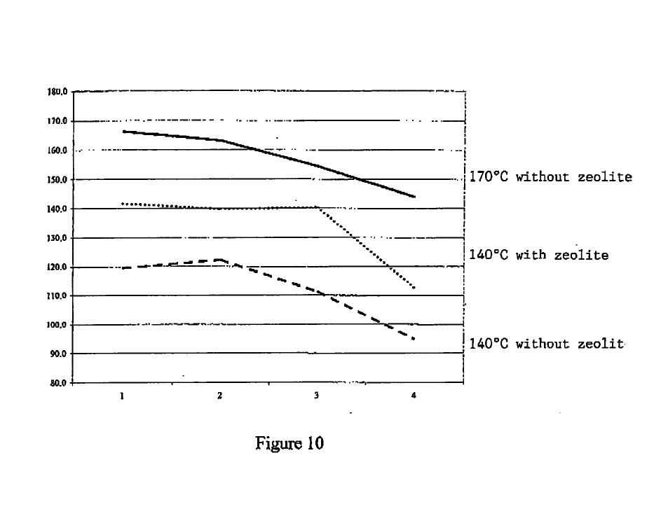

FIG. 10 represents temperature developments on a work site implementing the warm bituminous coatings.

FIGS. 1 and 2 are two diagrams representing the principle of the manufacturing process of a bitumen-bonded construction material mixture, in particular a bituminous concrete. FIG. 1 represents a batch production method and FIG. 2 represents a continuous method.

Pursuant to the embodiment of FIG. 1, aggregates are initially dried in a drum 10, then strained (operation 12) and subsequently separated by grain size and stored (operation 14). Then, these aggregates are introduced into a mixer 16 according to the bitumen-bonded construction material that is to be produced. In the alternative, the aggregates can be fed to the mixer 16 directly after the drum 10 (arrow 18).

Then the bituminous binder is introduced by spraying or by atomizing (arrow 20) into the mixer 16, in which the aggregates have a temperature in the range of 110° C. to 160° C.

Furthermore, an additive having a high desorption ability with temperature, such as in particular a zeolite, which has been removed from a silo 22 using a weighing device 24, is introduce by spraying or atomizing (26) into the mixer 16 or the additive is metered in together with a filler such as rock dust (arrows 28, 30). In the alternative, the additive having a high desorption ability with temperature can be stored and transported in disposable bags commonly known as non-returnable bags. The additive in said bags can be poured into the dosing hoppers or it can be poured directly into the mixer (22′).

These measures allow the bitumen-bonded construction material mixture to be produced at considerably lower temperatures compared to conventional method. Considerably lower in this case means in the range of at least 30° C. below the temperature that is generally applied. After an overall duration of about 40 to 60 seconds, during which the aggregates have been mixed with the bituminous binder, the additive and any fillers in the mixer 16, the bituminous mixture is pulled from the mixer (arrow 32), and the mixer is filled again in the above-described manner.

FIG. 2 shows the basic principle of a continuous method. In this case, the drier 10 and the mixer 16 from to FIG. 1 comprise a unit in the form, for example, of a drier (coater) 34 into which the aggregates are introduced at one end (arrow 36) for drying in the drier 34. The bitumen is added after the necessary drying process of the aggregates, for example by spraying or by atomizing (arrow 38). Preferably before that a filler (arrow 40) as well as an additive having a high desorption ability with temperature that have been weighed and remove from a silo (arrow 44) are added, whereby alternatively the additive can be supplied together with the filler by means of, for example, a screw conveyor of the drying drum 34 while the filler and the additive are mixed during addition process. This joint introduction is indicated by the arrow in broken lines 46. According to another advantageous alternative embodiment, bags of additives can be poured directly into the drier drum (34); this operation is indicated by the dotted arrow 42′. After coating the aggregates with bituminous binder, the final bituminous product is immediately removed (arrow 49) from the drier drum 34. The method described here is performed continuously.

FIGS. 8 and 9 make explain in more detail the two processes described above using either a mixer 16 or the drier drum 34. FIG. 8 is the block diagram of a mixer 16, whose bottom part is equipped with rotating arm 52, 54 milling parts 48, 50 for imparting a turbulent movement to the aggregates introduced. Above the milling parts 48, 50 the mixer is equipped with an arrangement of ducts 56 used for the spraying or atomizing of the bituminous binder for coating the aggregates while bituminous binder being turbulently moved by the milling parts 48, 50. In order to be able to perform this mixing operation at relatively low temperatures, an additive having a high desorption ability with temperature is introduced, advantageously in the form of a zeolite, by means of a conveyer device 58, which can also be a nozzle configuration or by means of a hatch or access system (22′) to the mixer. Together with the additive or separate from it, a filler such as rock dust can also be introduce. As shown in FIG. 1, batch production of a bitumen-bonded construction material takes place in mixer 16.

FIG. 9 is provided to illustrate the continuous process according to FIG. 2. A mixing element 60, which likewise assume the form of a forced action mixing element with downwardly rotating arm 62, extends in the drying drum 34 largely across its entire length, also in order to swirl the aggregates that have been fed at the beginning of the drying drum 34 via an opening 64 and dry it initially to the necessary extend. For this purpose, the aggregates are heated to about 110° C. to 160° C. Then the fillers are introduced by means of a feeding device 66 to a certain distance from the charging opening 64. At a distance thereto and consequently delayed time, the introduction of the additive having a high desorption ability with temperature is done in order to produce the desired bituminous mixture at relatively low temperatures. After that, bituminous binder is sprayed or atomized via an atomizing or spraying device 70 in order to coat the aggregate with bituminous binder to the necessary extend. Finally, the finished bituminous product is removed via an outlet port 72.

In order to be able to realize the dosing of the required additive, which is advantageously introduced at the quantity of 0.1 to 5 percent by weight, in particular 0.2 to 0.8 percent by weight, of the mixture of aggregate, bitumen and fillers, a silo 74 is provided, the dimensions of which are of such that it can be transported on a truck 76. The silo 74 is equipped with a support frame 76. Apart from filling ports 78, 80 which are arranged on the sides of the silo 74 as well as filling and ventilation lines, which are not described in detail, in order to offer ventilation to the silo 74, it is also equipped with a vibrator a console with a vibrator 82 in order to ensure a desired flow behavior of the additive stored in the silo 74.

In order to realize the correct dosing of the additive and transport to the mixer 16 or to the drier drum 34, a cart 88 with a wheel metering device 90 is aligned with the opening 84 of the silo 74. The cell wheel metering device 90 can be actuated via an electric motor 92. Then the metered additive is fed to a pressurized feeding container 94. A rotary compressor 96 then produces the compressed air used for feeding the additive to the mixer 16 or to the drier drum 34. In the alternative, the additive can be placed on a screw conveyer, via which the filler is added to the mixer 16 or the drying drum 34.

The cart 88 furthermore contains a control station 98. Threaded spindles 100, 102 allow the horizontal alignment of the rolling chassis.

The following examples illustrate the present invention without limiting its scope.

### EXAMPLE 1

### Physical and Chemical Properties of Type A Zeolite in Granule Form

Type A zeolite has the following chemical formula: Na₁₂ (AlO₂)₁₂(SiO₂)₁₂27H₂O, wherein the quantity of Na₂O is 18%, Al₂O₃ is 28%, SiO₂ is 33% and H₂O is 21%.

The physical and chemical properties of a type A zeolite in the granule form are the following:

| Average particle size | 380 μm |
|---|---|
| Density | 2.0 g/cm³ |
| Bulk density | 550 ± 50 g/L |
| Loss on calcination | 20% |
| pH (1% in water) | 11 |

### EXAMPLE 2

### Characteristics of Zeolite in Powder and Granule Form

Table 1, below, presents the granulometric characteristics of a type A zeolite in powder and granule form.

TABLE 1

| | | | Granule after |
|---|---|---|---|
| | | | elimination |
| | | | of the |
| Zeolites | Powder | Granule | adhesive |
| Average diameter | 10 | 500 | 3 |
| Bulk dry density | 0.475 | 0.624 | — |
| (t/m³) | | | |
| Wet density, actual | 1.974 | — | 2.141 |
| (t/m³) | | | |

Tables 2 and 3, below, show the water loss measurements of the powder and granule zeolites before and/or after elimination of the adhesive as a function of time and temperature in laboratory assays.

Table 2, below, shows the results obtained at laboratory assay in static mode. Accordingly, for a temperature applied, the loss in mass of each sample was observed over time.

TABLE 2

| | | | | Granule after | | |
|---|---|---|---|---|---|---|
| | | | | elimination of the | | |
| Zeolites | Powder | | | adhesive | | |
| Temperature (° C.) | 140 | 160 | 180 | 140 | 160 | 180 |
| Water loss (%) | 13.6 | 17.2 | 21.2 | 14.7 | 17.1 | 18.8 |

| | | |
|---|---|---|
| Holding time | approximately 15 | approximately 6 |
| | hours | hours |

Table 3, below, shows the results obtained at laboratory assay in dynamic mode using DSC with temperature variation over time (5° C./min).

TABLE 3

| | | Granule | |
|---|---|---|---|
| | | before | Granule after |
| | | elimination | elimination |
| | | of the | of the |
| Zeolites | Powder | adhesive | adhesive |
| Temperature (° C.) | 140 | 140 | 140 |
| Water loss (%) | 11.6 | 12.3 | 15.5 |

### EXAMPLE 3

### Comparative Work Site

We conducted a comparative study of BBSG 0/10 coating manufacture with and without zeolite. The purpose of this study was to evaluate the role of zeolite in granule form on handling of so-called “hot” coatings and to quantify the savings made in energy heating the granule.

The use of these BBSG 0/10 5 cm thick coatings made of 35/50 bitumen in a bonding layer was also the object of a study using temperatures and compacting mode.

A core bore on the work site was provided for determining the actual compactness and the modulus of the coating.

Working Method

Manufacturing Plans:

With and without zeolite: 140 t/h done under the same conditions.

The following assays were done:
Trial 1: BBSG without zeolite at a coating temperature of 170° C.
Trial 2: BBSG with zeolite at a coating temperature of 140° C.
Trial 3: BBSG without zeolite at a coating temperature of 140° C.
   Granule Drying Procedure:
Trial 1: 180° C.
Trial 2: 150° C.
Trial 3: 150° C.
   Coating Mixing Procedure:

To be adjusted in order to obtain the coating temperatures shown below:
Temperature of the 35/50 bitumen: 165° C.
Dry mixing with zeolites: add 20 seconds
Introduction of the bitumen
Mixing: 15 seconds
Coating temperature without zeolites: 170° C.
Temperature with zeolites for the last 50 tons: 140° C.

Measurements for vapors and emitted aerosols at the time of implementation were done by equipping the 2 application workers, the paver table, the paver operator and the compactor operator with sensors.

Situation of the Experimental Work Site

In the month of October, mild weather with occasional rain and wind.

Formulation of the 0/10 BBSG

The compositions tested are given in Table 4, below:

TABLE 4

| | | BBSG without |
|---|---|---|
| Compositions | BBSG with zeolites | zeolites |
| 6/10 crushed | 33.5% | 33.5% |
| Noubleau | | |
| 2/6 crushed | 21% | 21% |
| Noubleau | | |
| 0/4 SEINE | 34% | 34% |
| 0/2 CCB | 10% | 10% |
| Lime [stone] filler | 1.5% | 1.5% |
| Zeolite granule | 0.3 ppc | — |
| 35/50 bitumen | 5.6 ppc | 5.6 ppc |
| Richness modulus | 3.59 | 3.59 |

Packaging of the Zeolite

The zeolite was sacked at a rate of 8 kg/sack in order to respect the dosing of 0.3% for 2.5 tons of coating per batch.

Recording of Temperatures at the Plant

The plant uses is a discontinuous charging coating station.

A listing of the edited study at the plant made it possible to collect the temperatures by coating type and by batch.

Evaluation of Gas Consumption

An economic statement based on the lowering of the coating temperature of the coatings with zeolite (170 to 140° C.) and the gas consumption study was calculated: the results are given in Table 5, below:

TABLE 5

| | | Coating | Gas | Output | |
|---|---|---|---|---|---|
| | Zeolite | Tonnage | Consumption | m³/ton | KW |
| 0/10 | No | 92.4 | 548 | 5.93 | 69 |
| 0/10 | Yes | 168 | 794 | 4.73 | 55 |

Power=11.60 kW/coating ton
The kW price paid by the power station is 0.0152 euros.
This gain is calculated at: (69-55)×0.0152=0.21 euros (or 1.4 FF/ton)
Temperatures of the 0/10 BBSG with and without Zeolites at the Work Site

The readings of coating temperatures were done:
On arrival at the work site (after approximately 1 hour in transit)
In the paver hopper
In the paver screw feeder
At the level of the paver table.

These are shown in FIG. 10.

Product Controls: Core Boring of the Coatings at the Work Site

The overlap between the core bore zone and the installation field of each truck relative to a specific production made it possible to obtain results—shown in Table 8, below—relating to the compactness of the zones ‘with’ and ‘without’ zeolite. The compacting method uses is immediate compacting. In order to be able to compare the results to each other, the values of the measured voids were then set to values for a coating thickness of 5 cm. The results are collected in Table 6, below.

TABLE 6

| | Core Bores | | | |
|---|---|---|---|---|
| | | | voids | |
| Manufacturing | | | for 5 cm | |
| Parameters | t (cm) | void (%) | (%) | Modulus |
| 17° C. without | 6.1 | 6.7 | 6.0 | 11,000 |
| zeolite, Trial 1 | | | | |
| 140° C. with | 4.8 | 5.3 | 6.6 | 12,400 |
| zeolite, Trial 2 | | | | |
| 140° C. without | 4.5 | 8.5 | 9.2 | 10,400 |
| zeolite, Trial 3 | | | | |

It can be seen that the introduction of the zeolite in granule form makes it possible to obtain lower void indices and a higher modulus, which translates into better handling.

Conclusion

Manufacture of the 0/10 BBSG based on zeolite did not present any particular problem. The gas savings due to the reduction in heating of the aggregates (170 to 140° C.) made it possible to realize a gain of the order of 0.21 euros per ton of coating.

Using identical compacting, the 0/10 BBSG with zeolite, coated at 140° C., has an average void percentage of 5.3%, lower than that of the reference 0/10 BBSG, which is 6.7% coated at 170° C. without zeolite. These results confirm that the reduction of coating temperature in the presence of zeolite in granule form does not prejudice handling, quite the contrary; whereas, the coating temperature reduction without zeolite results in bituminous coatings that are more difficult to compact.

Furthermore, after analysis of the evolution of temperatures along the course of the coatings, it appears that the zeolite makes it possible to maintain the temperature while the coating remains intact in the truck.

### EXAMPLE 4

### Measurement of Airborne Emissions Released by the Bitumens at the Road Construction Work Sites

At the work site of Example 3, the airborne emissions and vapors were measured in the vicinity of the:
paver operator (P)
compactor operator (C)
paver table, left (LS) and right (RS)

The results are collected in Table 7, below. These measurements were made by an independent German organization.

TABLE 7

| | | | 140° C. with | |
|---|---|---|---|---|
| | 170° C. without | | zeolite | |
| | zeolite | | | Aerosols + |
| | Aerosols | Aerosols + vapor | Aerosols | vapor |
| | (mg/m³) | (mg/m³) | (mg/m³) | (mg/m³) |
| Paver | <0.8 | 0.8 to | <0.36 | 0.50 to |
| | | 1.2 | | 1.0 |
| Table left | <0.8 | 0.9 to | <0.36 | 0.36 to |
| | | 2.7 | | 0.6 |
| Table right | <0.8 | <0.8 | <0.36 | 0.36 to |
| | | | | 0.5 |
| Compactor | <0.8 | 1.7 | <0.36 | 1.0 |

It was found in all of the cases that emissions into the atmosphere are reduced when the coating temperature is reduced.

1. A method for producing a bitumen-bonded construction material mixture, in particular a bituminous concrete or bituminous coatings, comprising the following steps:
a) drying in a mixer (coater) of aggregates at a temperature T₁ of between 110 and 160° C. then;
b) coating of said aggregates, which are at temperature T₁, by spraying into the mixer (coater) of a bituminous binder which is heated at a temperature T₂ of between 140 and 190° C.;
and wherein, prior to and/or during the spraying of the bituminous binder, an additive having high desorption capacity with temperature in the form of granules is introduced into the mixer, said granules comprising fine particles of said additive aggregated by means of an adhesive, said fine particles having an average diameter of between 2 μm and 4 μm.

2. The method according to claim 1, wherein the temperature T₂ of heating of the bituminous binder is higher than the drying temperature T₁ of the aggregates.

3. The method according to claim 2, wherein the temperature T₂ of heating of the bituminous binder is higher by about 30° C. than the drying temperature T₁ of the aggregates.

4. The method according to claim 1, wherein the granules of the additive introduced have an average diameter of between 0.2 mm and 1 mm.

5. The method according to claim 1, wherein the fine particles have a specific surface of between 8,000 and 25,000 cm²/g.

6. The method according to claim 5, wherein the fine particles have a specific surface of at least 15,000 cm²/g.

7. The method according to claim 1, wherein the water content of the additive is 5 to 30% by weight, relative to the total weight of the additive.

8. The method according to claim 7, wherein the water content of the additive is 15 to 25% by weight, relative to the total weight of the additive.

9. The method according to claim 1, wherein natural and/or synthetic zeolite or its initial amorphous synthesis phase is used as the additive.

10. The method according to claim 9, wherein fiber zeolite, leaf zeolite and/or cube zeolite is used as the zeolite.

11. The method according to claim 10, wherein faujasite, chabasite, phillipsite, clinoptilolite and/or paulingite is used as the zeolite.

12. The method according to claim 11, wherein synthetic zeolite of the type A, P, X and/or Y is used as the zeolite.

13. The method according to claim 1, wherein the fine particles release more than 70% of their water in less than 6 hours at a temperature of between 140 and 180° C., at the time of trials conducted in the laboratory.

14. The method according to claim 1, wherein the additive is introduced into the mixer at a quantity of 0.1% to 5% by weight, relative to the total weight of the mixture.

15. The method according to claim 14, wherein the additive is introduced into the mixer at a quantity of 0.2 to 0.8% by weight relative to the total weight of the mixture.

16. The method according to claim 1, wherein fillers are further introduced prior to and/or during the spraying of the bituminous binder.

17. The method according to claim 16, wherein the fillers are introduced at the same time as the additive.

18. The method according to claim 16, wherein the fillers are fine rock dusts.

19. The method according to claim 1, wherein bitumen, special bitumen, modified bitumen, polymer-modified bitumen or mixtures thereof are used as bituminous binders.

20. A bitumen-bonded construction material mixture, in particular a bituminous concrete or bituminous coatings, obtainable by the method according to claim 1, wherein, at the time of its implementation, the emissions of aerosols are less than 0.5 mg/m³.

21. A mixture according to claim 20, wherein, at the time of its implementation, the emissions of aerosols are lower than 0.36 mg/m³.

22-26. (canceled)

27. A device for conducting the method according to claim 1, comprising a mixer for mixing the aggregates, the bituminous binder, the additive and possibly fillers, wherein the additive is stored in a silo (74, 22), the outlets (84) of the silo are connected with a weighing device (24), and said weighing device is connected to the mixer (16, 34) via a conveying device.

28. The device according to claim 27, wherein the conveying device is a conveyor for the filler that is supposed to be supplied to the mixer (16, 34).

29. The device according to claim 27, wherein the conveying device is a pneumatic conveyor, which leads to a spraying device (58, 68) present in the mixer (16, 34).

30. The device according to claim 27, wherein the silo has a mobile or stationary design.

31. The device according to claim 27, wherein the mobile silo (74) is dimensioned such that it can be transported on a truck (76).

32. The device according to claim 27, wherein the additive can be supplied via a cell wheel lock (90) and a weighing device that is arranged after this in series.

33. The device according to claim 27, wherein a control station (98), a weighing device and a conveying device (96) are arranged on a cart (88) that can be aligned on the silo (74).

34. The device according to claim 27, wherein the conveying device (96) comprises a rotary compressor (96) in front of which a pressurized conveying container (94) is arranged.
